(19) United States
(12) Patent Application Publication
(10) Pub. No.: US 2004/0137866 A1
(43) Pub. Date: Jul. 15, 2004

(54) Preset station receiver and preset station receiving method

(75) Inventor: Jun Miyamura, Kawagoe-shi (JP)

Correspondence Address: MCGINN & GIBB, PLLC, 8321 OLD COURTHOUSE ROAD, SUITE 200, VIENNA, VA, 22182-3817, US

(73) Assignee: Pioneer Corporation, Tokyo (JP)

(21) Appl. No.: 10/653,974

(22) Filed: Sep. 4, 2003

(30) Foreign Application Priority Data
May 9, 2002 (JP) 2002-259820

(51) Int. Cl. H04B 1/18

(52) U.S. Cl. 455/185.1

(57) ABSTRACT

A receiving apparatus and a preset station setting method, in which even when a reception area is changed, the latest preset stations which can be received are always held, and when the reception area is not changed, the preset stations can be protected. Receiving states of the preset stations are checked. If it is determined that the receiving states of all of the preset stations are deteriorated, the preset stations are rearranged. When rearranging the preset stations, a plurality of stations in a predetermined band are received and the stations are arranged into the preset stations in the order of goodness of the receiving state. When the station in the good receiving state cannot be detected, the conventional preset stations are maintained.

### BACKGROUND OF THE INVENTION

1. Field of the Invention

The invention relates to a receiving apparatus which can receive preset stations and a setting method of the preset stations.

2. Description of the Related Art

Car-audio apparatuses have been subjected to a constraint such that the stations which have been preset as the radio signal source cannot be received after a long distance travel. This situation is especially grave when the car moves over a long distance while a user is listening to a non-radio signal source such as a compact disc player. When the user subsequently effects a switch to a radio signal source, it is no more possible to receive a formerly selected preset station since the reception areas of the former broadcast stations are too distant from the current position.

Hitherto, in order to solve the above-described problem, a construction of a radio signal source as described below has been known as a measure to change the preset stations in cases where the radio signal source is set to what is called a background signal source. In such car-audio apparatuses, the background signal source denotes a source in a state where although power supplies of various signal sources such as radio and compact disc player have been turned on, they are not presently selected as an audio signal source. That is, when a signal source such as a compact disc player or a cassette deck is used in the car-audio apparatus, the radio signal source becomes the background signal source. On the other hand, the source which is presently selected as an audio signal source in the car-audio apparatus is called a foreground signal source. Therefore, during the car radio listening, the radio signal source is the foreground signal source and the signal source such as compact disc player or cassette deck player becomes the background signal source.

As a prior art to provide a function of changing the preset stations, there for example is a radio signal source having a construction such that broadcast stations near the vehicle position are extracted by using a position information detecting apparatus such as GPS (Global Positioning System) and the preset stations are reorganized by using those stations (refer to Japanese patent Kokai No. 8-222998). There also is a radio signal source having a construction such that when the radio source is a background signal source, monitoring of a receiving state of the station received as a foreground signal source (hereinafter, simply referred to as a “last station”) lastly is performed, and the preset stations are reorganized when it is determined that the receiving state has deteriorated.

In the former example, however, since the preset stations are reorganized simply based on geographical conditions, there for example is a possibility that the preset stations which have newly been rearranged cannot be received near a boundary of the reception areas due to the uncertainty of a radio wave propagating state which is generally affected by a landscape or ground objects. In the latter case, there is a possibility that when the received radio wave from the last station is attenuated due to a temporary factor such as passage in a tunnel, even in a situation where another preset station is sufficiently receivable, preset stations are newly rearranged by using the stations other than the preset stations.

### SUMMARY OF THE INVENTION

It is, therefore, an object of the invention to solve the problems described above. Another object of the invention is to provide a receiving apparatus in which even when the reception area is changed due to a long distance movement, the apparatus is always maintained in a latest state where preset stations can be received, and when the reception area is not changed, the apparatus can protect preset stations.

According to the invention, there is provided a receiving apparatus comprising: a tuner unit for generating a receiving state signal indicative of a receiving state of a radio wave; a memory device for storing a plurality of preset stations; and a control apparatus for changing the preset stations, wherein the control apparatus discriminates deterioration of a receiving state of each of the preset stations based on the receiving state signal, and when it is determined that the receiving states of all of the preset stations deteriorated, the control apparatus changes the preset stations stored in the memory device.

According to the invention, there is provided a method for setting preset stations in a receiver, comprising: a first step of storing a plurality of preset stations; a second step of detecting a receiving state of each of the plurality of preset stations stored in the first step; and a third step of changing the preset stations stored in the first step if it is detected based on a detection result in the second step that the receiving states of all of the preset stations deteriorated.

### BRIEF DESCRIPTION OF THE DRAWINGS

FIG. 1 is a block diagram showing a radio with a preset station changing function as an embodiment of the invention;

FIG. 2 is a flowchart showing an outline of the changing operation of preset stations in the radio of FIG. 1;

FIG. 3 is a flowchart showing the operation of a preset station receiving state storing process in FIG. 2;

FIG. 4 is a diagram of memory register construction showing the construction of memories 1 and 2;

FIG. 5 is a flowchart showing the operation of a background BSM process in FIG. 2;

FIG. 6 is a construction diagram of memory registers showing the construction of memories 3 and 4; and

FIG. 7 is a memory transition diagram showing a state of a memory setting process in the background BSM process.

### DETAILED DESCRIPTION OF THE PREFERRED EMBODIMENTS

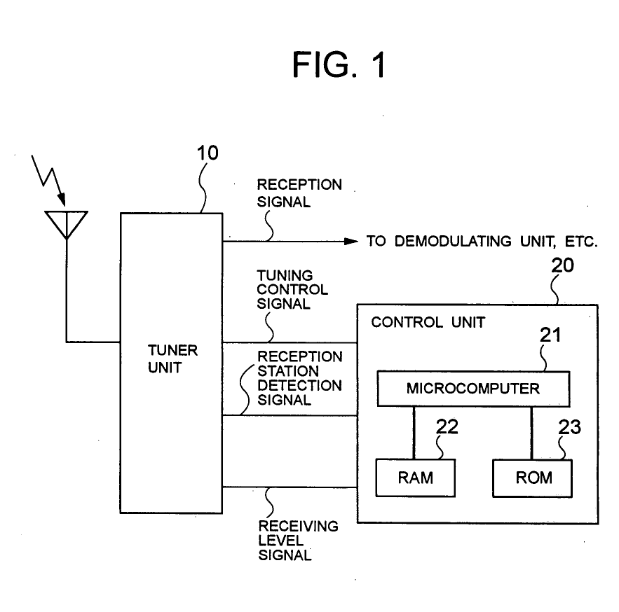

A radio with a preset station changing function as an embodiment of a receiving apparatus according to the invention is shown in a block diagram of FIG. 1.

In the diagram, a tuner unit 10 is a portion which includes a tuning circuit, a high frequency/intermediate frequency amplifying circuit, a detecting circuit, and the like and performs functions such as what is called front-end, intermediate frequency process, and detection in the radio. A reception station detection signal indicative of the presence or absence of a reception station and a receiving level signal showing a signal level of the received station are generated from the tuner unit 10 to a control unit 20, which will be explained later. The selection of the reception station in the tuner unit 10 is made based on a tuning control signal which is supplied from the control unit 20. Naturally, a reception signal detected by the tuner unit 10 is supplied to a post stage circuit such as demodulating unit or audio amplifying unit (they are not shown), converted into an audio signal, and outputted from an audio device such as a speaker.

The control unit 20 is constituted mainly by a microcomputer 21, a RAM (Random Access Memory) circuit 22, a ROM (Read Only Memory) circuit 23, and their peripheral circuits. Various flag registers and memory registers which are necessary at the time of the operation of the embodiment are provided for the RAM circuit 22. Various programs which specify the operation of the apparatus have been stored in the ROM circuit 23. Those programs are executed step by step synchronously with a clock built in the microcomputer 21 under the control of predetermined timing, so that an operating process in the embodiment is executed.

The RAM circuit 22 and the ROM circuit 23 shown in FIG. 1 are not limited to ordinary semiconductor memories but other memory media such as a hard disk drive can be also used.

The tuner unit 10, RAM circuit 22, and microcomputer 21 in the embodiment correspond to a tuner unit, a memory device, and a control apparatus in the embodiment of the invention, respectively.

Subsequently, the operation of the process of changing the preset stations in the embodiment will be described.

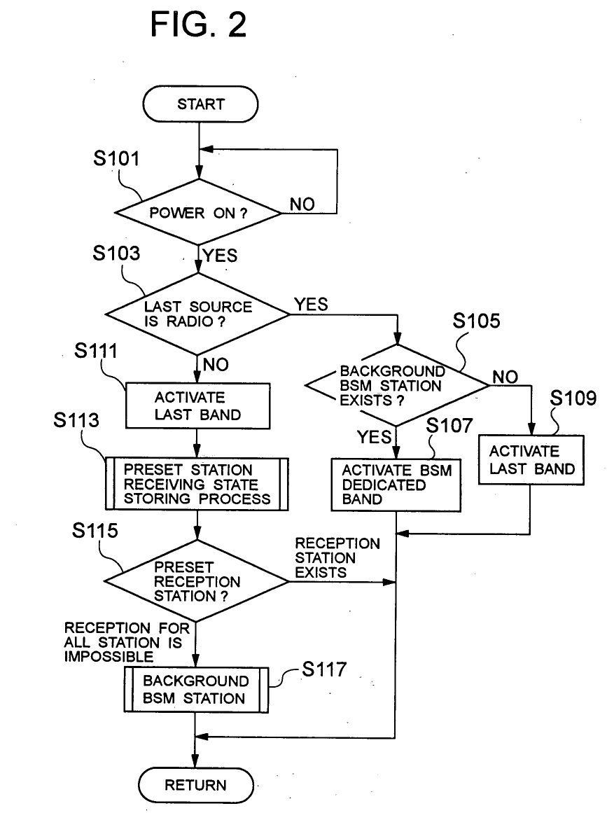

First, a schematic flowchart showing the whole operation is shown in FIG. 2. A subroutine program shown in the flowchart can be activated by, for example, switching on the power supply of a car audio apparatus including a radio source according to the embodiment. It is also possible to arrangement that the subroutine program is activated by pressing a predetermined reset switch. Furthermore, it is also possible to adopt an arrangement that the subroutine program is periodically activated by a predetermined timer while a main routine program for integrally controlling the operation of the radio source as a whole shown in FIG. 1 is operating.

When the subroutine program shown in FIG. 2 is activated, the microcomputer 21 of the control unit 20 (hereinafter, simply referred to as a “microcomputer”) detects whether or not the power source of each unit of the car audio apparatus has been turned on normally in step S101. If it has been turned on normally, the processing routine advances to next step S103.

In step S103, the microcomputer detects whether or not a last signal source is a radio signal source. It is assumed that the last signal source indicates a signal source used as a foreground signal source upon operation of the car audio apparatus before the subroutine program is activated.

If the last signal source indicates the radio signal source, the microcomputer advances to step S105 and detects whether or not reception stations have been detected by a background BSM process. The BSM (Best Stations Memory) process here denotes a process for storing a frequency of the station in the best receiving state into the memory register in order from a better signal level of the reception station. The background BSM process denotes a BSM process executed when the radio signal source is the background signal source. The background BSM process itself will be described in detail in a subroutine program in subsequent step S117.

If it is determined in step S105 that at least one receivable station has been detected in the background BSM process, the microcomputer advances to step S107 and activates the reception of a BSM dedicated band based on the frequency of the stored reception station in order to use the station detected in the background BSM process.

If it is determined in step S105 that the receivable station is not detected in the background BSM process, the microcomputer advances to step S109 and activates the reception of a last band. The last band denotes a band of the radio signal source received in the case where the last signal source is the radio signal source. When the reception station cannot be detected in the background BSM process while the radio signal source is OFF, thus, the reception of the last band including the last station is reconstructed.

After completion of the process in step S107 or S109 mentioned above, the microcomputer finishes the subroutine program and returns to the main routine program.

If the last source is, for example, a compact disc player or a cassette deck player other than the radio source in step S103, the control advances to step Sill.

When the microcomputer activates the reception of the last band in step S111 in a manner similar to step S109, it advances to next step S113 and executes a subroutine program of a preset station receiving state storing process, which will be explained later. When the process of the subroutine program in step S113 is finished and the control is returned to the processing flow, the microcomputer discriminates the receiving states of the preset stations by using a processing result in the subroutine program (step S115).

In step S115, the microcomputer discriminates contents of a reception station presence/absence discriminating memory for a background BSM, which will be explained later. If there is at least one receivable preset station, the microcomputer finishes the subroutine program shown in the flowchart and returns to the main routine program (not shown). In this case, therefore, the construction of the conventional preset stations is maintained as it is.

If it is determined in step S115 that all of the preset stations cannot be received, the microcomputer advances to step S117 and activates a subroutine program of the background BSM process. When the control is returned from the subroutine program, the microcomputer finishes the subroutine program in the flowchart and returns to the main routine program.

As described above, in the embodiment, only when it is determined that all of the preset stations cannot be received, the preset stations are changed by the background BSM process and if at least one of the preset stations can be received, the preset stations will not be changed. For example, therefore, even if the receiving state of the last station or a partial preset station deteriorates temporarily and the stations cannot be received, the stations which have been preset to the radio signal source are not newly rearranged.

Subsequently, details of the subroutine program of the preset station receiving state storing process which is activated in step S113 in the flowchart of FIG. 2 will be described.

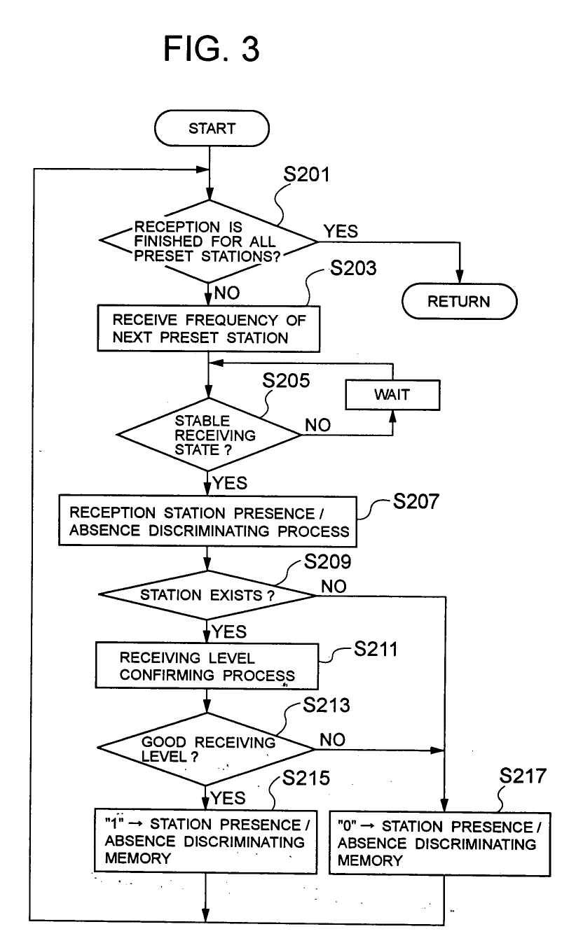

A flow for the processing operation in the subroutine program is shown in a flowchart of FIG. 3.

When the subroutine program is activated, the microcomputer first detects whether or not the check of the receiving state has been finished with respect to all of the preset stations in step S201 of the flowchart. For example, if there are six stations (6 channels) which have been preset in the radio signal source, detection is performed as to whether or not the check of the receiving state has been finished with respect to all of the preset stations of 6 channels. The preset channel number (the number of stations) corresponds to the number of preset operation buttons provided for an operation unit (not shown) of the radio signal source.

If it is determined in step S201 that the check of the receiving state has been finished with respect to all of the preset channels, the microcomputer finishes the subroutine program and returns to a process subsequent to step S113 of the flowchart shown in FIG. 2.

If it is determined in step S201 that the check of the receiving state is not finished with respect to all of the preset stations, the microcomputer advances to step S203 and accesses a preset station frequency memory for BSM (hereinafter, simply referred to as a “memory 1”).

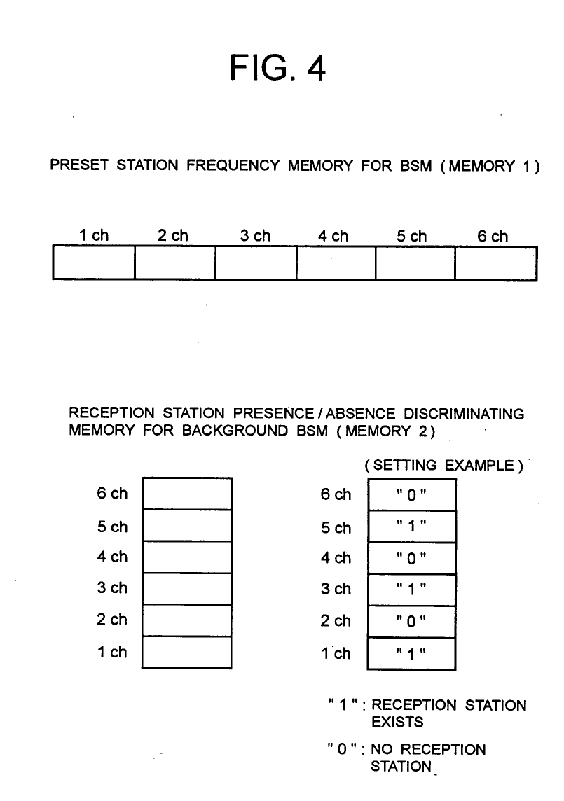

The memory 1 is a memory register provided in the RAM circuit 22 and its construction is shown in a memory register construction diagram of FIG. 4. As mentioned above, in the embodiment, it is assumed that preset stations of 6 channels exist correspondingly to six preset operation buttons. The memory 1, therefore, is constructed by the memory register comprising six areas corresponding to the preset channels and it is assumed that a receiving frequency of each preset channel has been stored in each area. In the embodiment, it is assumed that the preset station of the first channel is the station of the highest priority and the preset station of the sixth channel is the station of the lowest priority. The channel number of the preset stations and the construction of the memory register shown in FIG. 4 are merely shown as examples and, naturally, the invention is not limited to them. This is true of constructions of various memory registers, which will be explained below.

When the microcomputer reads out the station frequency of the preset channel to be checked next from the memory 1 in step S203, it generates a predetermined tuning control signal in order to receive that frequency and supplies it to the tuner unit 10. In the tuning circuit and frequency converting circuit in the tuner unit 10, a radio wave of the frequency instructed by the tuning control signal is selected and received and a detecting circuit effects a detecting process on the received radio wave.

If the preset channels are arranged cyclically, there can be a situation that an upper limit frequency and a lower limit frequency of the receiving frequency band of the preset stations are set in neighboring preset channels, so that a fear arises such that the operation of the tuning circuit or the like becomes transiently unstable by the switching of the receiving frequencies. To stabilize the receiving state, therefore, the microcomputer generates a command to the tuner unit 10 in step S203 and, thereafter, repeats a waiting mode (WAIT) for a predetermined period of time (step S205). The progress of the program can be also returned once to the main routine program during the WAIT period of time.

When the waiting mode in step S205 is finished and the receiving state in the tuner unit 10 becomes stable, the microcomputer transfers the control to step S207. The microcomputer fetches a reception station detection signal which is generated from the tuner unit 10 and detects whether or not the reception station has actually been detected at the frequency of the preset station set in the tuner unit 10.

For example, a logic signal showing that the synchronization of a PLL (Phase Locked Loop) in the detecting circuit in the tuner unit 10 has been established at the set receiving frequency can be used as a reception station detection signal, or a logic signal showing that a value of an intermediate frequency obtained after completion of the frequency conversion in the tuner unit 10 is within a predetermined range can be also used. In any of the above cases, when the reception station is detected at the frequency set in the tuner unit 10, the reception station detection signal is turned on and, if it is not detected, the signal is turned off. The presence or absence of the detection of the reception station can be, therefore, discriminated by checking the on/off state of the logic signal.

When the reception station is detected as a result of the check of the reception station detection signal in step S207, the microcomputer transfers the control to step S211 and, if it is not detected, the microcomputer transfers the control to step S217 (step S209).

First, if it is determined that there is no reception station, the microcomputer accesses a reception station presence/absence discriminating memory for background BSM (hereinafter, simply referred to as a “memory 2”) in step S217 and sets “0” into a memory area corresponding to the preset channel which is being checked at present. The memory 2 denotes a memory register provided in the RAM circuit 22 as shown in FIG. 4 and each area corresponds to each preset channel among 1ch to 6ch. That is, if the reception station whose receiving state is being checked at present is the station of 4ch, “0” is set into the memory area of 4ch in step S217.

If it is determined that the reception stations exist, the microcomputer advances to step S211, further fetches the receiving level signal which is generated from the tuner unit 10, and discriminates a magnitude of the signal level of the station received by the tuner unit 10.

If it is determined that the receiving level is equal to or larger than a predetermined threshold value, the microcomputer advances to step S215 and sets “1” into the area of the corresponding channel in the memory 2. If it is determined that the receiving level is smaller than the predetermined threshold value, step S217 follows and “0” is set into the area.

That is, when it is determined that there is no reception station or even when the presence of the reception stations has been determined, if it is determined that the signal levels from the stations do not reach the threshold value necessary for assuring the good receiving state, “0” is set into the area of the corresponding channel in the memory 2. Only when the reception stations exist and the signal levels from the stations can assure the good receiving state, “1” is set into the area of the corresponding channel in the memory 2.

After completion of the process in step S215 or S217, the microcomputer returns to step S201 of a start point of the subroutine program. The above processes are repeated until the check of the receiving states of all of the preset stations is completed. In other words, when the check of the receiving states of all of the preset stations is finished, for example, as shown in the setting example of the memory 2 in FIG. 4, “0” or “1” is set into the area corresponding to each preset channel in the memory 2 in accordance with the result of the receiving state check.

Subsequently, the subroutine program of the background BSM process which is activated in step S117 in FIG. 2 will be described.

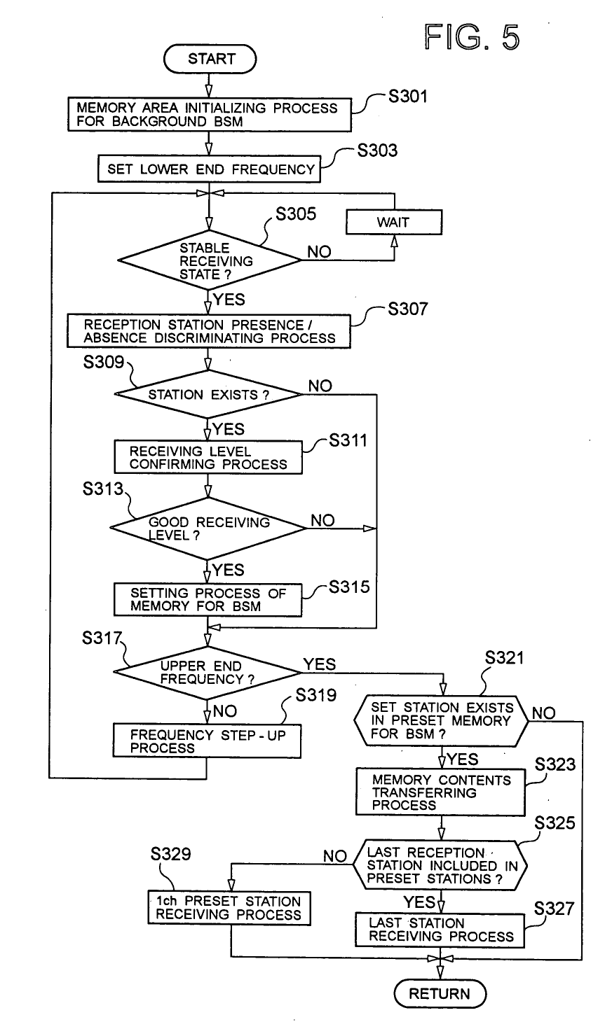

A flow for the processing operation in the subroutine program is shown in a flowchart of FIG. 5.

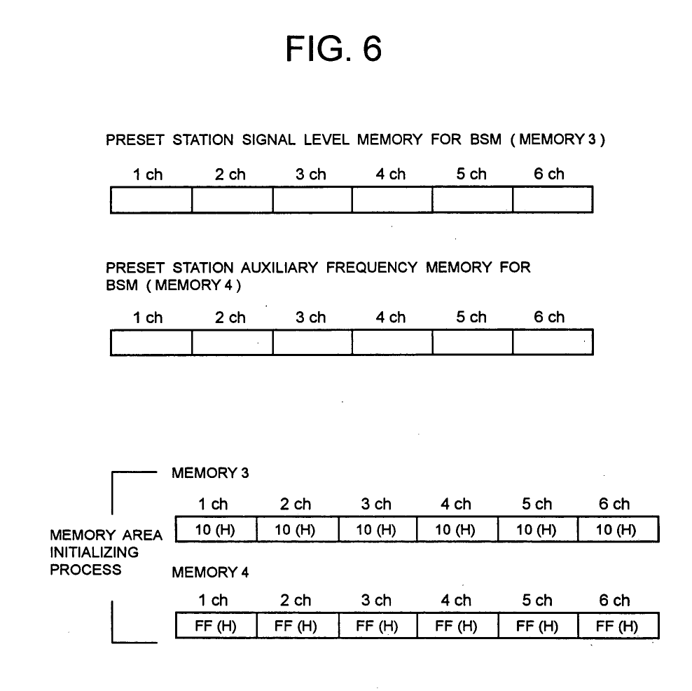

When the subroutine program is activated, first, the microcomputer initializes each memory register which is used in the background BSM process in step S301 of the flowchart. As memory registers which are used in the subroutine program, there are two memory registers: a preset station signal level memory for BSM (hereinafter, simply referred to as a “memory 3”) and a preset station auxiliary frequency memory for BSM (hereinafter, simply referred to as a “memory 4”). Those memory registers are provided in the RAM circuit 22 in a manner similar to the foreground other memory registers and their constructions are shown in a memory register construction diagram of FIG. 6. Naturally, each area in the memory registers corresponds to each station among 1ch to 6ch of the preset channels.

In step S301, as shown in a memory area initializing process in FIG. 6, a hexadecimal code “10(H)” is set into each area in the memory 3 and a hexadecimal code “FF(H)” is set into each area in the memory 4, respectively. Those initialization codes are shown merely as examples and the construction of the embodiment of the invention is not limited to those examples.

When the initializing process of the memory areas in step S301 is finished, the microcomputer starts a searching process for detection of the reception stations.

First, in step S303, a lower end frequency of a frequency band where the searching process is executed is set. That is, the microcomputer supplies a tuning control signal based on that frequency to the tuner unit 10. In the tuner unit 10, a radio wave of the frequency is selected and subjected to receiving and detecting processes.

It is now assumed that a value of the lower end frequency can be set to one of various values in dependence on the frequency band where the searching process is executed. For example, it is set to 76.0 MHz in the case of an FM broadcasting band (76.0 to 90.0 MHz) and is set to 522 kHz in the case of an AM-broadcasting band (522 to 1629 kHz). In the case of searching another broadcasting band, a value that is peculiar to its band is used.

In consideration of the transient fluctuation in association with the switching of the receiving frequencies in the tuner unit 10, the microcomputer repeats the waiting mode (WAIT) for a predetermined period of time in order to stabilize the receiving state (step S305). The progress of the program can be also returned once to the main routine program during the WAIT period of time.

When the WAIT period of time in step S305 is finished, the microcomputer advances to step S307. The microcomputer fetches the reception station detection signal which is generated from the tuner unit 10 and detects whether the reception station has actually been detected at the frequency of the preset station set in the tuner unit 10 or not. Since the reception station detection signal has been described in detail by the subroutine program of the preset station receiving state storing process mentioned above, its details are omitted here.

If it is determined in next step S309 that the reception station of the relevant frequency does not exist, the microcomputer advances to step S317. If it is determined in step S309 that the reception station of the relevant frequency exists, the microcomputer advances to step S311, fetches the receiving level signal which is generated from the tuner unit 10, and detects whether the radio wave from the reception station is at a level enough to assure the good receiving state or not (step S313).

If it is determined in step S313 that the receiving level is not good, the microcomputer advances to step S317. If it is determined that the receiving level is good, the microcomputer advances to step S315 and executes a setting process of the memory 3 and the memory 4. Contents of the memory setting process in step S315 will be described later.

After completion of the process in step S315, the microcomputer advances to step S317 and detects whether the frequency at which the above processes have been executed has reached the upper end frequency of the frequency band as a target of the searching process or not.

If it is determined in step S317 that the receiving frequency does not reach the upper end frequency yet, the microcomputer raises the receiving frequency step by step. When the processing routine returns to step S305, the microcomputer repetitively executes the searching process described above. The step-up of the receiving frequency is executed in a manner similar to the case where it is executed by the manual operation in an ordinary radio. For example, it is set to a step of 9 kHz in the case of the AM broadcasting band (522 to 1629 kHz) and is set to a step of 0.1 MHz in the case of the FM broadcasting band (76.0 to 90.0 MHz), respectively.

If it is determined in step S317 that the receiving frequency has reached the upper end frequency, the microcomputer recognizes that the searching process has been completed, so that it transfers the control to step S321.

Although the searching process has been executed by stepping up the receiving frequency from the lower end frequency in the frequency band in the flowchart shown in FIG. 5, the operation of the embodiment of the invention is not limited to the above example. For example, the searching process can be executed by stepping down the receiving frequency from the upper end frequency in the frequency band, or it is also possible to preliminarily extract only the stations which can be received at the present location by using position data from the position information detecting apparatus such as a GPS and execute the searching process within a range of the extracted stations.

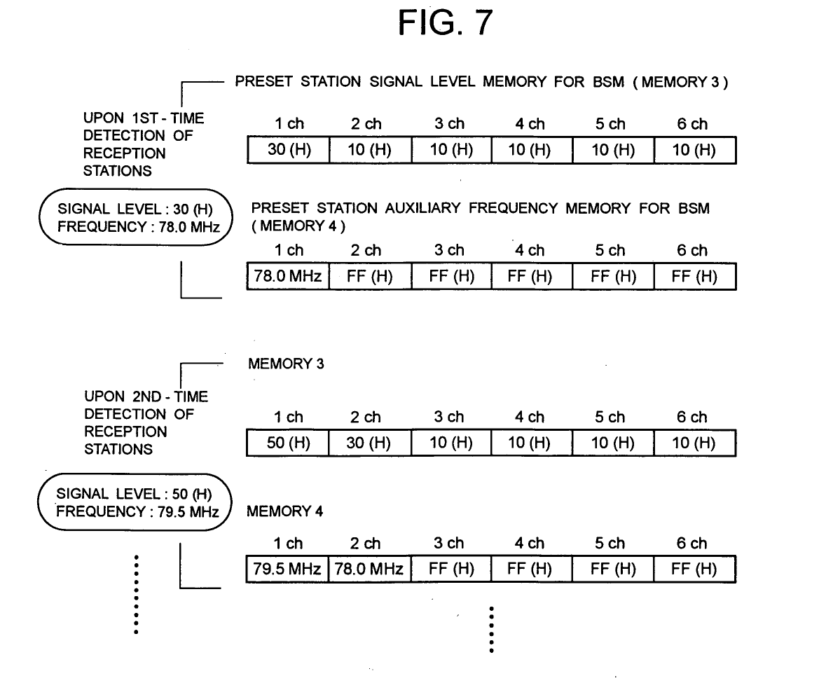

Subsequently, an outline of the memory setting process in step S315 will be described with reference to a memory transition diagram shown in FIG. 7.

For example, the frequency of the receivable station which was detected after the start of the searching process of the reception stations is assumed to be 78.0 MHz and its reception signal level is assumed to be 30(H). As a value of the reception signal level, the value of the actual reception signal is analog/digital converted, transformed into a relative value on the basis of a predetermined reference, and expressed by a hexadecimal code. At this time, as shown in FIG. 7, 30(H) as a reception signal level of the same station is stored into 1ch (the first channel) in the memory 3 and 78.0 MHz as a frequency of the same station is stored into 1ch in the memory 4.

The frequency of the station which was detected at the second time and can be received in the subsequent searching process is assumed to be 79.5 MHz and its reception signal level is assumed to be 50(H). It is assumed that data is written into the memory 3 from the first channel (1ch) in order from the better signal level of the reception station, that is, from the higher signal level. As shown in FIG. 7, therefore, the signal level 50(H) of the present reception station is stored into the first channel (1ch) in the memory 3 and the signal level 30(H) of the previous reception station is shifted to the second channel (2ch) in the memory 3. With respect to the channels in the memories 3 and 4, since the correspondence relation is always maintained, 79.5 MHz as a frequency of the present reception station is also stored into the first channel. (1ch) in the memory 4 and 78.0 MHz of the previous reception station is shifted to the second channel (2ch).

At a point of time when all of the searching processes in the predetermined frequency band are completed, therefore, that is, at a point of time when the control is shifted to step S321, the frequencies of the reception stations have been preset into the areas of ch1 to ch6 in order from the higher reception signal level.

In step S321, the microcomputer checks the status of the memory 3 or the memory 4. If the contents in those memories have been held to the contents upon initialization executed in step S301, the background BSM process, that is, the subroutine program is finished and the control is returned to step S117 of the schematic flowchart shown in FIG. 2. In this case, it means that the receivable station could not be detected in the background BSM process.

If at least one receivable station has been stored in the memory 4 in step S321, the microcomputer advances to step S323 and transfers the contents in the reception stations stored in the memory 4 to the memory 1. The preset stations which have been arranged by the background BSM process and stored in the memory 4 are, consequently, transferred as a foreground source into the memory 1 as a preset memory which is used when they operate as foreground sources.

Subsequently, the microcomputer detects whether or not the last station is included in the preset stations newly rearranged by the background BSM process (step S325). If the last station is included, step S327 follows. The microcomputer instructs the tuning unit to receive the last station, thereafter, finishes the subroutine program, and returns to step S117 of the schematic flowchart shown in FIG. 2.

If it is determined in step S325 that the last station is not included in the preset stations, the microcomputer advances to step S329, instructs the tuning unit to receive the station of ch1 in the preset memory (memory 1), and thereafter, returns to step S117 of the schematic flowchart shown in FIG. 2.

By the above processes, in the case where the background BSM process is executed at a place of a poor radio wave propagating environment such as underground or multilevel parking lot and the reception station cannot be detected by the searching process, the conventional preset stations stored in the memory 1 (preset station frequency memory for BSM) are held.

When the radio source is returned from the background source to the foreground source, if the last station exists in the stations which were preset by the background BSM process, the user can continuously listen to that station. If the last station does not exist in the stations which were preset by the background BSM process, he can listen to the station in the best receiving state among the preset stations.

The receiving apparatus according to the invention is not limited to the embodiment described above but, for example, as a receiving apparatus having the preset station changing function, a television signal source can be used in place of the radio signal source.

User preset frequency memories which are uniformly set by the manual operation can be also used together with the preset frequency memory for BSM. It is, thus, possible to also prevent a situation that the user stores his favorite preset stations into the user preset frequency memory and the user's favorite preset stations are destroyed by the movement such as long distance trip.

As described in detail above, according to the invention, there is provided the receiving apparatus comprising: the tuner unit for generating the receiving state signal indicative of the receiving state of the radio wave; the memory device for storing a plurality of preset stations; and the control apparatus for changing the preset stations, wherein the control apparatus discriminates deterioration of a receiving state of each of the preset stations on the basis of the receiving state signal, and when it is determined that the receiving states of all of the preset stations deteriorated, the control apparatus changes the preset stations stored in the memory device.

According to the invention, there is provided the setting changing method of the preset stations in the receiving apparatus, comprising: the first step of storing a plurality of preset stations; the second step of detecting the receiving state of each of the plurality of preset stations stored in the first step; and the third step of changing the preset stations stored in the first step if it is detected on the basis of the detection result in the second step that the receiving states of all of the preset stations deteriorated.

According to the embodiment, even when the reception area is changed by the long distance movement, the preset stations are always held in the latest state and when the reception area is not changed, even if the receiving state deteriorates temporarily, the set preset stations can be protected.

This application is based on Japanese Patent Application No. 2002-259820 which is herein incorporated by reference.

What is claimed is:

1. A receiving apparatus comprising:
a tuner unit for generating a receiving state signal indicative of a receiving state of a radio wave;
a memory device for storing a plurality of preset stations; and
a control apparatus for changing said preset stations,
wherein said control apparatus discriminates deterioration of a receiving state of each of said preset stations on the basis of said receiving state signal, and when it is determined that the receiving states of all of said preset stations deteriorated, said control apparatus changes the preset stations stored in said memory device.

2. An apparatus according to claim 1, wherein when said preset stations are changed, said control apparatus allows said tuner unit to receive radio waves from a plurality of stations existing in a predetermined band, selects the stations whose receiving states are good on the basis of said receiving state signal, and allows them to be stored into said memory device.

3. An apparatus according to claim 2, wherein when the station having a good receiving state cannot be selected, said control apparatus maintains the preset stations stored in said memory device.

4. An apparatus according to claim 1, wherein said control apparatus executes the changing process of said preset stations even when said receiving apparatus is in a nonuse mode, and when the receiving apparatus is made operative, the preset stations stored in said memory device in the nonuse mode are used as preset stations in an operative mode of the receiving apparatus.

5. An apparatus according to claim 2, wherein said control apparatus executes the changing process of said preset stations even when said receiving apparatus is in a nonuse mode, and when the receiving apparatus is made operative, the preset stations stored in said memory device in the nonuse mode are used as preset stations in an operative mode of the receiving apparatus.

6. An apparatus according to claim 3, wherein said control apparatus executes the changing process of said preset stations even when said receiving apparatus is in a nonuse mode, and when the receiving apparatus is made operative, the preset stations stored in said memory device in the nonuse mode are used as preset stations in an operative mode of the receiving apparatus.

7. A receiving apparatus comprising:
tuner means for generating a receiving state signal indicative of a receiving state of a radio wave;
storing means for storing a plurality of preset stations; and
control means for changing said preset stations,
wherein said control means discriminates deterioration of a receiving state of each of said preset stations on the basis of said receiving state signal, and when it is determined that the receiving states of all of said preset stations deteriorated, said control means changes the preset stations stored in said storing means.

8. An apparatus according to claim 7, wherein when said preset stations are changed, said control means allows said tuner means to receive radio waves from a plurality of stations existing in a predetermined band, selects the stations whose receiving states are good on the basis of said receiving state signal, and allows them to be stored into said storing means.

9. An apparatus according to claim 8, wherein when the station whose receiving state is good cannot be selected, said control means maintains the preset stations stored in said storing means.

10. An apparatus according to claim 7, wherein said control means executes the changing process of said preset stations even when said receiving apparatus is in a nonuse mode, and when the receiving apparatus is made operative, the preset stations stored in said storing means in the nonuse mode are used as preset stations in an operative mode of the receiving apparatus.

11. An apparatus according to claim 8, wherein said control means executes the changing process of said preset stations even when said receiving apparatus is in a nonuse mode, and when the receiving apparatus is made operative, the preset stations stored in said storing means in the nonuse mode are used as preset stations in an operative mode of the receiving apparatus.

12. An apparatus according to claim 9, wherein said control means executes the changing process of said preset stations even when said receiving apparatus is in a nonuse mode, and when the receiving apparatus is made operative, the preset stations stored in said storing means in the nonuse mode are used as preset stations in an operative mode of the receiving apparatus.

13. A setting changing method of preset stations in a receiving apparatus, comprising:
a first step of storing a plurality of preset stations;
a second step of detecting a receiving state of each of the plurality of preset stations stored in said first step; and
a third step of changing the preset stations stored in said first step if it is detected on the basis of a detection result in said second step that the receiving states of all of said preset stations deteriorated.
